(19) United States
(12) Patent Application Publication
(10) Pub. No.: US 2024/0054181 A1
(43) Pub. Date: Feb. 15, 2024

(54) OPERATION CIRCUIT, OPERATION METHOD, AND PROGRAM

(71) Applicant: NIPPON TELEGRAPH AND TELEPHONE CORPORATION, Tokyo (JP)

(72) Inventors: Yuya OMORI, Musashino-shi (JP); Ken NAKAMURA, Musashino-shi (JP); Daisuke KOBAYASHI, Musashino-shi (JP); Koyo NITTA, Musashino-shi (JP)

(73) Assignee: NIPPON TELEGRAPH AND TELEPHONE CORPORATION, Tokyo (JP)

(21) Appl. No.: 18/256,005

(22) PCT Filed: Dec. 9, 2020
(86) PCT No.: PCT/JP2020/045854

§ 371 Date: Jun. 5, 2023

(51) Int. Cl. G06F 17/16; G06F 7/50

(52) U.S. Cl. CPC G06F 17/16; G06F 7/50

(57) ABSTRACT

One aspect of the present invention is an operation circuit for performing a convolution operation of input feature map information supplied as a plurality of channels and coefficient information supplied as a plurality of channels, the operation circuit including a set including at least two channels of an output feature map based on output channels and at least three sub-operation circuits, wherein at least two sub-operation circuits are allocated for each set, the sub-operation circuits included in the set execute processing of a convolution operation of the coefficient information and the input feature map information included in the set, when a specific channel of the output feature map is a zero matrix, a sub-operation circuit that performs a convolution operation of the zero matrix executes processing of a convolution operation of the coefficient information and the input feature map information to be supplied next from a channel of the output feature map and a channel of the input feature map included in the set, and a result of the convolution operation is output for each channel of the output feature map.

### TECHNICAL FIELD

The present invention relates to technology of an operation circuit, an operation method, and a program.

### BACKGROUND ART

In the case of performing inference by using a trained convolutional neural network (CNN) or in the case of learning a CNN, convolution processing is performed in a convolution layer, but this convolution processing is the same as repeated product-sum operation processing. In CNN inference, the aforementioned product-sum operation (referred to as “MAC operation” hereinafter) occupies most of the total throughput. Even when a CNN inference engine is implemented as hardware, the operation efficiency and implementation efficiency of a MAC operation circuit greatly affect the entire hardware.

In the convolution layer, output feature map data oFmap is obtained by performing convolution processing of Kernel that is a weight coefficient on input feature map data iFmap that is feature map data of a result of the previous layer. The input feature map data iFmap and the output feature map data oFmap are composed of a plurality of channels. These are called iCH_num (number of input channels) and oCH_num (number of output channels). Since convolution of the Kernel is performed between channels, the Kernel has the number of channels corresponding to (iCH_num×oCH_num).

FIG. 13 is an image diagram of a convolution layer. The example of FIG. 13 shows a convolution layer for generating output feature map data oFmap having oCH_num=3 from an input feature map iFmap having iCH_num=2.

In the case where such convolution layer processing is implemented as hardware, oCH_num parallel MAC operation units are prepared and a parallel method of performing kernel MAC processing on the same input channel number in parallel and repeating this processing iCH_num times is used in order to improve the throughput by parallelization.

FIG. 14 is a diagram showing a MAC operation circuit example and an example of processing flow. In the configuration shown in FIG. 14, a convolution layer generates output feature map data oFmap having oCH_num=4 from input feature map data iFmap having iCH_num=5, for example. In this case, for example, four MAC operation units 910 are prepared in parallel, and the MAC operation units 910 are moved five times. Each MAC operation unit 910 requires a memory 920 for temporarily storing a result of an arithmetic operation of the output feature map data oFmap. The memory 920 requires four memories 921 to 924 for oCHm (m is an integer of 0 to 3). As shown in FIG. 14, in the (n+1)-th (n is an integer of 0 to 4) processing, iFmap data of iCHn is supplied to the four MAC operation units 911 to 914 as the input feature map data iFmap. As weight coefficient data Kernel, kernel data of iCHn & oCH0 is supplied to the MAC operation unit 911, kernel data of iCHn & oCH1 is supplied to the MAC operation unit 912, kernel data of iCHn & oCH2 is supplied to the MAC operation unit 913, and kernel data of iCHn & oCH3 is supplied to the MAC operation unit 914. At the beginning of each layer, data in each memory is initialized to 0. Kernel data of a certain channel in which an input channel number is n and an output channel number is m is represented as “kernel data of iCHn & oCHm.”

In the first processing in which a convolution operation of iCH0 is performed, the MAC operation unit 911 performs convolution integration of iCH0*oCH0, adds the operation result and stores the result in the memory 921. The MAC operation unit 912 performs convolution integration of iCH0*oCH1, adds the operation result and stores the result in the memory 922. The MAC operation unit 913 performs convolution integration of iCH0*oCH2, adds the operation result and stores the result in the memory 923. The MAC operation unit 914 performs convolution integration of the iCH0*oCH3, adds the operation result and stores the result in the memory 924. Obtaining an output channel having an output channel number of m(oCHm) by performing a convolution operation of kernel data having an input channel number of n and an output channel number of m on an input channel having an input channel number of n(iCHn) is represented as “iCHn*oCHm.”

Subsequently, in the second processing, input feature map data iFmap of iCH1 is supplied to the MAC operation units 911 to 914, and product-sum operation processing of Kernel is performed by each MAC operation unit. The operation result is stored in the memories 921 to 924 by adding convolution results of iCH0 and iCH1 thereto. That is, in the second processing for performing a convolution operation of the iCH1, a product-sum operation result of iCH0*oCH0+iCH1*oCH0 is stored in the memory 921, a product-sum operation result of iCH0*oCH1+iCH1*oCH1 is stored in the memory 922, a product-sum operation result of iCH0*oCH2+iCH1*oCH2 is stored in the memory 923, and a product-sum operation result of iCH0*oCH3+iCH1*oCH3 is stored in the memory 924.

In the fifth processing, input feature map data iFmap of iCH4 is supplied to the MAC operation units 911 to 914, and product-sum operation processing of Kernel is performed by each MAC operation unit. The operation result is stored in the memories 921 to 924 by adding convolution results from iCH0 to iCH4 thereto. Since the final operation result becomes the output feature map data oFmap in such processing, the data in the memory 920 is determined as the oFmap result of the present convolution layer. When the next layer is a convolution layer again, the same processing is performed by using the output feature map data oFmap as input feature map data iFmap of the next layer. In a configuration like that shown in FIG. 14, the product-sum operation can be simultaneously performed on the common input feature map data iFmap, and the throughput can be easily improved by parallelization. Further, in a configuration like that shown in FIG. 14, operation units and memories are one-to-one pairs, and the final convolution result can be obtained by simply adding the operation result of each iCH to memory data attached to the operation unit, and thus the circuit configuration is simple.

### CITATION LIST

### Non Patent Literature

[Non Patent Literature 1] Norman P. Jouppi, Cliff Young, et al. “In-Datacenter Performance Analysis of a Tensor Processing Unit TM,” the 44th International Symposium on Computer Architecture (ISCA), 2017

### SUMMARY OF INVENTION

### Technical Problem

Meanwhile, there are more than a few cases in which some of the input feature map data iFmap and input data of the kernel become 0. In such a case, the product-sum operation is not necessary (because it is processing for multiplying by 0). In particular, since each channel is generally smaller in size than Fmap such as 3×3 or 1×1, kernel data may be a channel in which kernel data of the channel is whole zero (zero matrix).

FIG. 15 is a diagram showing sparse kernel data. In FIG. 15, hatched squares 951 represent non-zero kernel data and non-hatched squares 952 represent sparse kernel data. In FIG. 15, 8 channels in channels of kernel data 20 are sparse in zero matrices. In operation processing, kernel data is used in the order of i, ii, iii, iv, and v. The MAC operation unit 911 is allocated to processing of kernel data 961 of oCH0, the MAC operation unit 912 is allocated to processing of kernel data 962 of oCH1, the MAC operation unit 913 is allocated to processing of kernel data 963 of oCH2, and the MAC operation unit 914 is allocated to processing of kernel data 964 of oCH4.

FIG. 16 is a diagram showing an example of a processing flow when sparse kernel data is supplied.

In the first processing in which a convolution operation of iCH0 is performed, kernel data of iCH0 & oCH1 and kernel data of iCH0 & oCH2 are zero matrices, and thus only 0 is added to data stored in the memory 922 and the memory 923. Therefore, the MAC operation unit 912 and the MAC operation unit 913 need not perform arithmetic operations. However, since calculation of the MAC operation unit 911 and the MAC operation unit 914 cannot be omitted, the MAC operation unit 912 and the MAC operation unit 913 have to wait for completion of these arithmetic operations in the hardware configuration according to the conventional technology shown in FIG. 14 and the like, and thus the MAC operation unit 912 and the MAC operation unit 913 are wasted.

When input data is sparse in this manner, the conventional technology has a problem that a sufficient arithmetic operation speed cannot be expected.

In view of the above-mentioned circumstances, an object of the present invention is to provide a technology capable of efficiently increasing an arithmetic operation speed while curbing an increase in hardware scale when some weight coefficients are zero matrices in product-sum operation processing in a convolution layer of a neural network.

### Solution to Problem

One aspect of the present invention is an operation circuit for performing a convolution operation of input feature map information supplied as a plurality of channels and coefficient information supplied as a plurality of channels, the operation circuit including a set including at least two channels of an output feature map based on output channels and at least three sub-operation circuits, wherein at least two sub-operation circuits are allocated for each set, the sub-operation circuits included in the set execute processing of a convolution operation of the coefficient information and the input feature map information included in the set, when a specific channel of the output feature map is a zero matrix, a sub-operation circuit that performs a convolution operation of the zero matrix executes processing of a convolution operation of the coefficient information and the input feature map information to be supplied next from a channel of the output feature map and a channel of the input feature map included in the set, and a result of the convolution operation is output for each channel of the output feature map.

One aspect of the present invention is an operation method for causing an operation circuit including a set including at least two channels of an output feature map based on output channels, and at least three sub-operation circuits to execute a convolution operation of input feature map information supplied as a plurality of channels and coefficient information, the operation method including: allocating at least two sub-operation circuits for each set; causing the sub-operation circuits included in the set to execute processing of a convolution operation of the coefficient information and the input feature map information included in the set; when a specific channel of the output feature map is a zero matrix, causing a sub-operation circuit that performs a convolution operation of the zero matrix to execute processing of a convolution operation of the coefficient information and the input feature map information to be supplied next from a channel of the output feature map and a channel of the input feature map included in the set; and outputting a result of the convolution operation for each channel of the output feature map.

One aspect of the present invention is a program causing a computer to realize the operation circuit according to one of the above-described aspects.

### Advantageous Effects of Invention

According to the present invention, it is possible to efficiently increase an arithmetic operation speed while curbing an increase in hardware scale when some weight coefficients are zero matrices in product-sum operation processing in a convolution layer of a neural network.

### BRIEF DESCRIPTION OF DRAWINGS

FIG. 1 is a diagram showing an operation circuit of an embodiment.

FIG. 2 is a diagram showing an example of a case in which 8 channels are sparse matrices among 20 channels of kernel data.

FIG. 3 is a diagram showing an example of allocation of MAC operation units in an embodiment.

FIG. 4 is a diagram showing an example of processing order used in kernel data according to an embodiment.

FIG. 5 is a diagram showing an example of first processing when sparsity has occurred in kernel data according to an embodiment.

FIG. 6 is a diagram showing an example of second processing when sparsity has occurred in kernel data according to an embodiment.

FIG. 7 is a diagram showing an example of third processing when sparsity has occurred in kernel data according to an embodiment.

FIG. 8 is a diagram showing an example of allocation and configuration of MAC operation units according to an embodiment.

FIG. 9 is a diagram showing assignment of MAC operation units to kernel data sets in the case of k=1.

FIG. 10 FIG. 9 is a diagram showing assignment of MAC operation units to kernel data sets in the case of k=4.

FIG. 11 is a flowchart of an example of a processing procedure of an operation circuit according to an embodiment.

FIG. 12 is a flowchart of a procedure of optimization of assignment of MAC operation units to kernel data sets in a modified example.

FIG. 13 is an image diagram of a convolution layer.

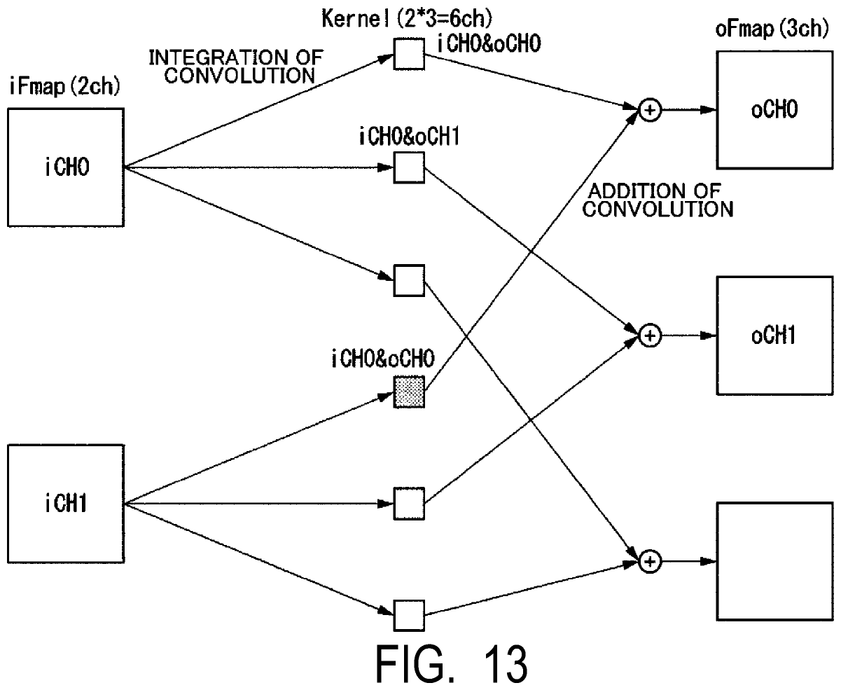

FIG. 14 is a diagram showing a MAC operation circuit example and an example of a processing flow.

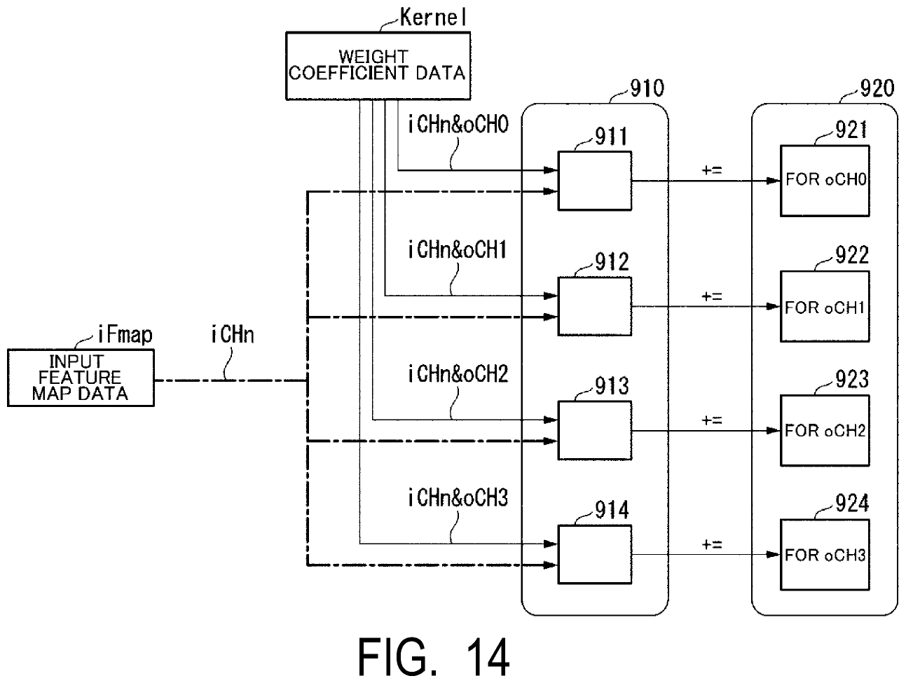

FIG. 15 is a diagram showing kernel data having sparsity.

FIG. 16 is a diagram showing an example of a processing flow when kernel data having sparsity is supplied.

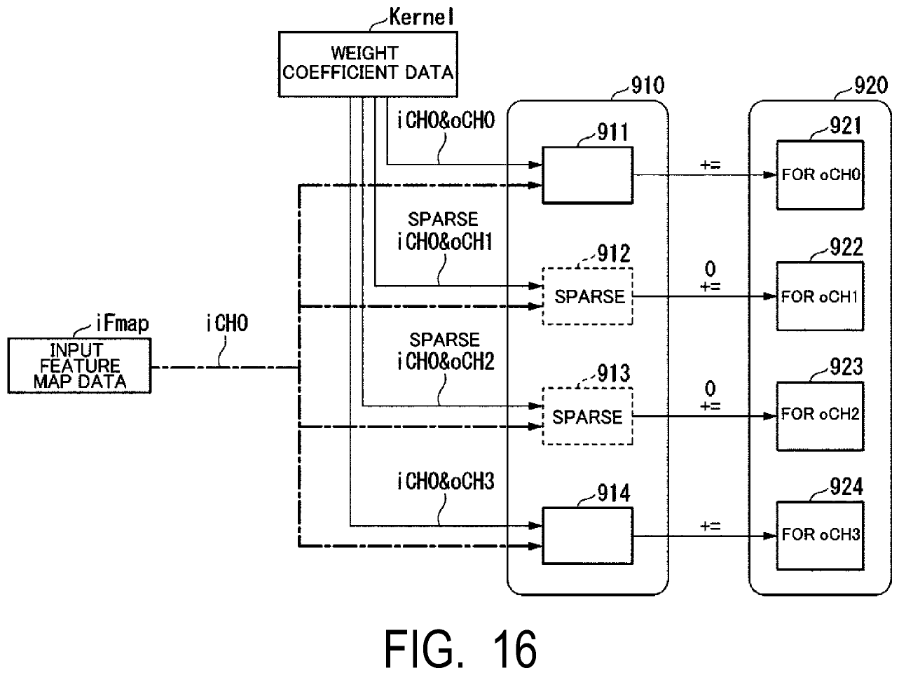

### DESCRIPTION OF EMBODIMENTS

An embodiment of the present invention will be described in detail with reference to the drawings. A method of the present embodiment can be applied to, for example, a case in which inference is performed using a trained CNN or a case in which a CNN is trained.

### <Configuration Example of Operation Circuit>

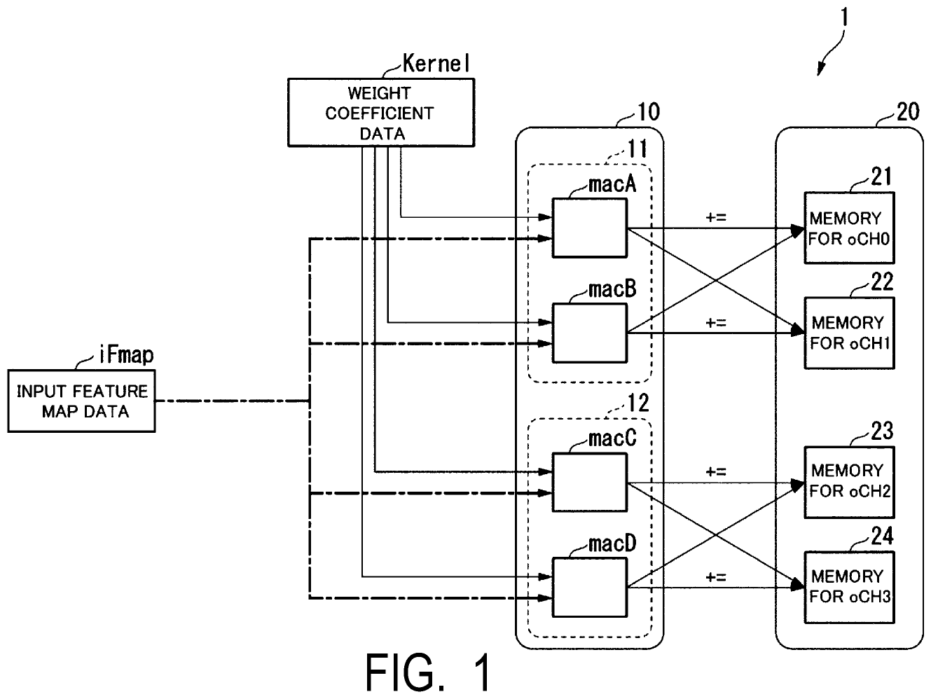

FIG. 1 is a diagram showing an operation circuit of the present embodiment. As shown in FIG. 1, the operation circuit 1 includes a sub-operation circuit 10 and a memory 20 for temporarily storing an operation result.

The sub-operation circuit 10 includes a MAC operation unit macA (sub-operation circuit), a MAC operation unit macB (sub-operation circuit), a MAC operation unit macC (sub-operation circuit), and a MAC operation unit macD (sub-operation circuit).

The memory 20 includes a memory 21 for oCH0, a memory 22 for oCH1, a memory 23 for oCH2, and a memory 24 for oCH3.

The operation circuit 1 is an operation circuit in a convolution layer of a CNN. The operation circuit 1 divides kernel data (coefficient information) that is weight coefficients into a plurality of sets including several output channels. The operation circuit 1 divides sets such that there are no channels belonging to two or more sets. Then, the operation circuit 1 allocates as many MAC operation units as the number of channels in a set to each set. Input feature map data iFmap and weight coefficient data (kernel data) Kernel are supplied to the MAC operation units.

Although FIG. 1 shows an example including four MAC operation units and four memories, the operation circuit 1 may include three or more MAC operation units and three or more memories and may include five or more MAC operation units and five or more memories. The number of MAC operation units and the number of memories are identical.

The operation circuit 1 is configured using a processor such as a central processing unit (CPU) and a memory or an operation circuit and a memory. The operation circuit 1 serves as MAC operation units, for example, by a processor executing a program. Note that all or some of the functions of the operation circuit 1 may be realized using hardware such as an application specific integrated circuit (ASIC), a programmable logic device (PLD), or a field programmable gate array (FPGA). The aforementioned program may be recorded in a computer-readable recording medium. The computer-readable recording medium is, for example, a storage device such as a portable medium such as a flexible disk, a magneto-optical disc, a ROM, or a CD-ROM, or a semiconductor storage device (e.g., solid state drive (SSD)), or a hard disk or a semiconductor storage device provided in a computer system. The aforementioned program may be transmitted via a telecommunication line.

### <Example of Input Data Having Sparsity>

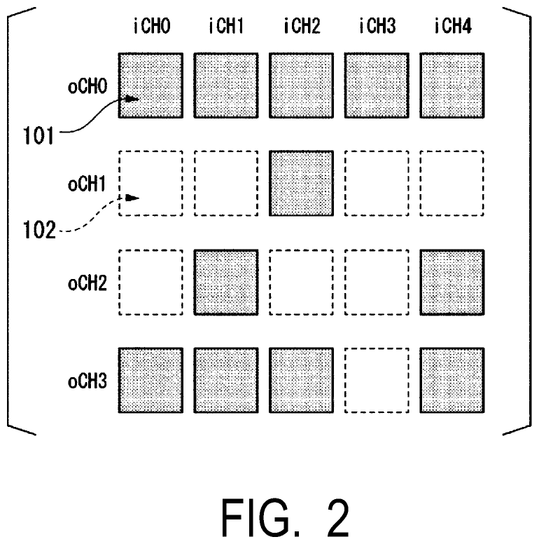

Next, a case of sparse kernel data will be described with reference to FIGS. 2, 3 and 15.

FIG. 2 is a diagram showing an example in which 8 channels are sparse matrices in 20 channels of kernel data. In FIG. 2, hatched squares 101 represent kernel data that is not a sparse matrix, and non-hatched squares 102 represent kernel data that is a sparse matrix. In the embodiment, a channel of sparse kernel data may also include a channel that is a matrix in which most data is zero and significant data is limited to a small number in addition to a channel that is a zero matrix. Sparse kernel data may be iCH0 & oCH1, iCH0 & oCH2, iCH1 & oCH1, iCH2 & oCH2, iCH3 & oCH1, iCH3 & oCH2, iCH3 & oCH3, and iCH4 & oCH1.

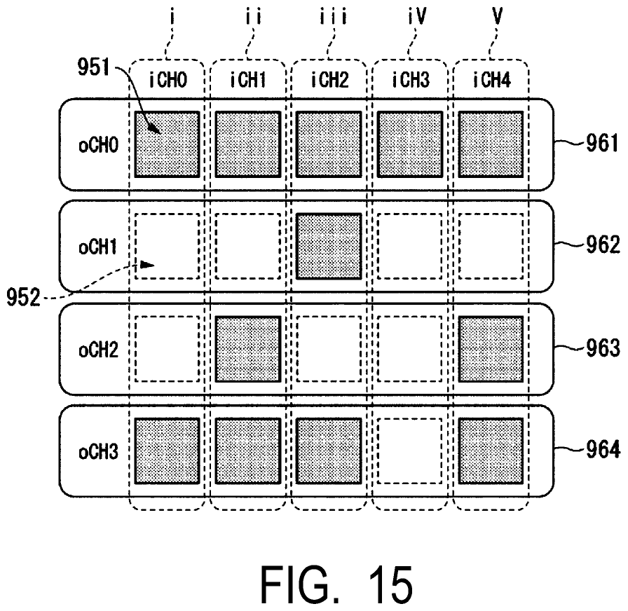

In conventional parallel processing, kernel data is used in the order of i, ii, iii, iv, and v, as shown in FIG. 15. Conventionally, each MAC operation unit has been allocated to processing of kernel data of oCHm, as shown in FIG. 15.

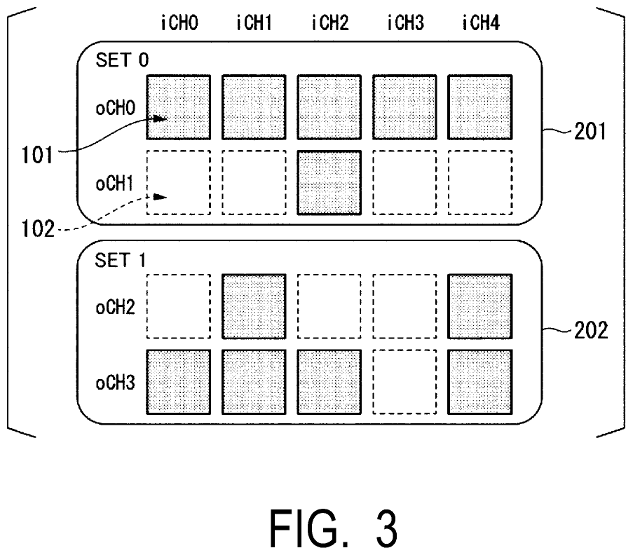

On the other hand, a plurality of oCHm are integrated as one set and a plurality of MAC operation units are allocated to one set in the present embodiment. FIG. 3 is a diagram showing an example of allocation of MAC operation units in the present embodiment. In the example of FIG. 3, two oCHm are set as one set. The first set 201 (set 0) is a set of oCH0 and oCH1. The second set 202 (set 1) is a set of oCH2 and oCH3. The operation device 1 is set to a set including channels of at least two output feature maps based on output channels included in kernel data.

As described above, a set of the present embodiment is configured based on channels of an input feature map and channels of output feature maps in input feature map data.

Furthermore, in the present embodiment, the processing order is not fixed as in the conventional manner, such as iCH0, iCH1, . . . , and product-sum operation processing is adaptively performed in the same set according to sparsity of kernel data, thereby achieving high speed processing.

### <Kernel Data Processing Order>

Next, an example of a processing order used in kernel data will be described.

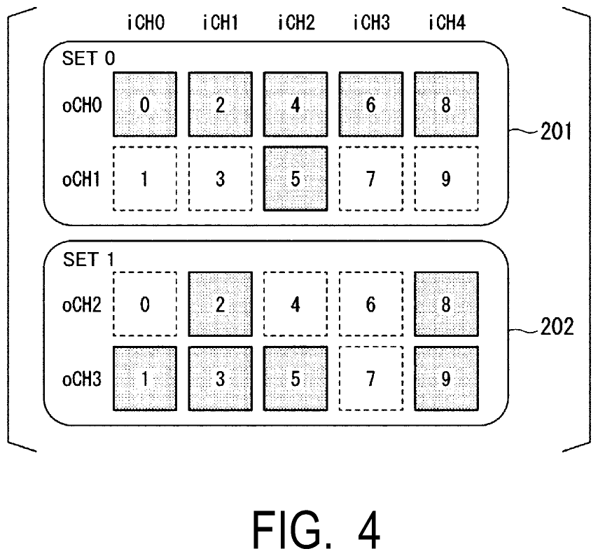

FIG. 4 is a diagram showing an example of a processing order used in kernel data according to the present embodiment.

The operation circuit 1 uses kernel data in the order of kernel data iCH0 & oCH0, iCH0 & oCH1, iCH1 & oCH0, iCH1 & oCH1, iCH2 & oCH0, iCH2 & OCH1, iCH3 & oCH0, iCH3 & oCH1, iCH4 & oCH0, and iCH4 & oCH1 in the first set 201 (set 0) of kernel data.

The operation circuit 1 uses kernel data in the order of kernel data iCH0 & oCH2, iCH0 & oCH3, iCH1 & oCH2, iCH1 & oCH3, iCH2 & oCH2, iCH2 & OCH3, iCH3 & oCH2, iCH3 & oCH3, iCH4 & oCH2, and iCH4 & oCH3 in the second set 202 (set 1) of the kernel data.

### (First Processing)

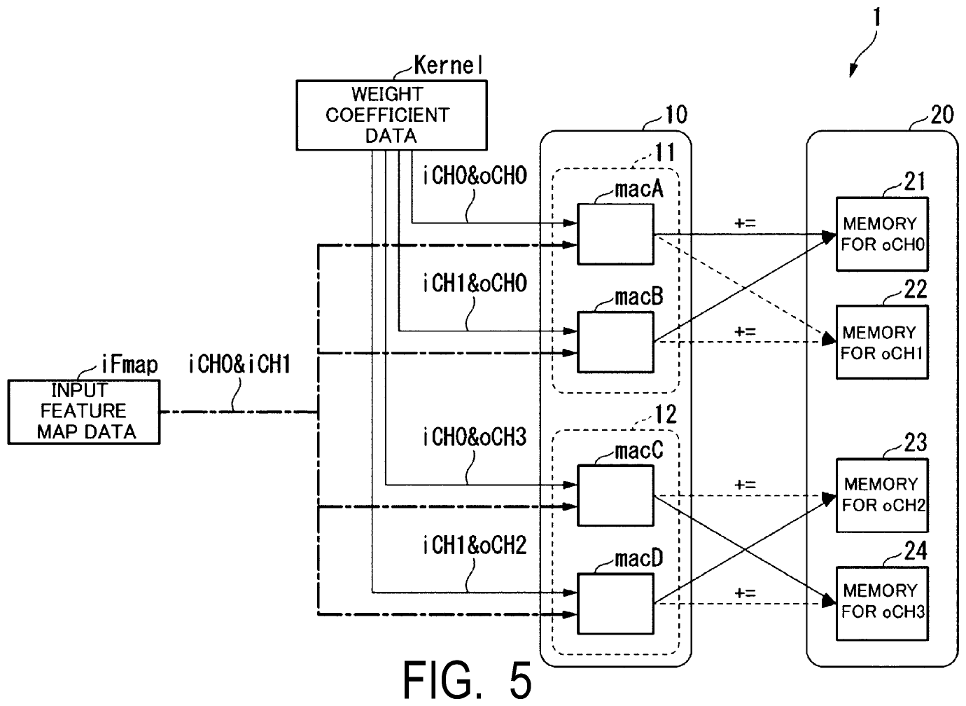

Next, an example of first processing when sparsity has occurred in kernel data will be described with reference to FIGS. 4 and 5.

FIG. 5 is a diagram showing an example of first processing when sparsity has occurred in kernel data according to the present embodiment. The MAC operation unit macA and the MAC operation unit macB of a first pair 11 are allocated to processing of the first set 201 (FIG. 3) of the kernel data. The MAC operation unit macC and the MAC operation unit macD of a second pair 12 are allocated to processing of the second set 202 (FIG. 3) of the kernel data. Further, data (iCH0 and iCH1) are supplied to each of the MAC operation units macA to macD from the input feature map data iFmap.

When a channel of kernel data that is a sparse matrix is present in each set of the kernel data, the operation circuit 1 performs a convolution operation of the next kernel data in the corresponding set and the feature map using a MAC operation unit to which the kernel data that is the sparse matrix should be allocated.

In FIG. 5, arrows of chain lines from the MAC operation units to oCHm indicate that addition to the memory is not performed because kernel data is skipped.

In the first set 201, an arithmetic operation is not necessary because kernel data iCH0 & oCH1 is a zero matrix. Therefore, the operation circuit 1 performs an arithmetic operation on the kernel data iCH0 & oCH0 in the first processing but skips the kernel data iCH0 & oCH1 and performs an arithmetic operation on the kernel data iCH1 & oCH0 preceding by one in the first set 201.

Accordingly, as shown in FIG. 5, the MAC operation unit macA stores the convolution integration result of iCH0*oCH0 in the memory 21 for oCH0 by adding the same thereto. The MAC operation unit macB stores the convolution integration result of iCH1*oCH0 in the memory 21 for oCH0 by adding the same thereto.

As a result, the arithmetic operation result of iCH0*oCH0+iCH1*oCH0 is stored in the memory 21 for oCH0. The arithmetic operation result is not added to the memory 22 for oCH1 and an initial value 0 remains therein.

In the second set 202, an arithmetic operation is not necessary because the kernel data iCH0 & oCH2 is a zero matrix. Therefore, the operation circuit 1 skips the kernel data iCH0 & oCH2 in the second set 202 and performs an arithmetic operation of the kernel data iCH0 & oCH3 preceding by one (skips kernel data corresponding to one channel) and a convolution operation of the kernel data iCH1 & oCH2 preceding by further one.

Accordingly, as shown in FIG. 5, the MAC operation unit macC stores the convolution integration result of iCH0*oCH3 in the memory 24 for oCH3 by adding the same thereto. The MAC operation unit macD stores the convolution integration result of iCH1*oCH2 in the memory 23 for oCH2 by adding the same thereto.

As a result, the arithmetic operation result of iCH1*oCH2 is stored in the memory 23 for oCH2. The arithmetic operation result of the iCH0*oCH3 is stored in the memory 24 for oCH3.

### (Second Processing)

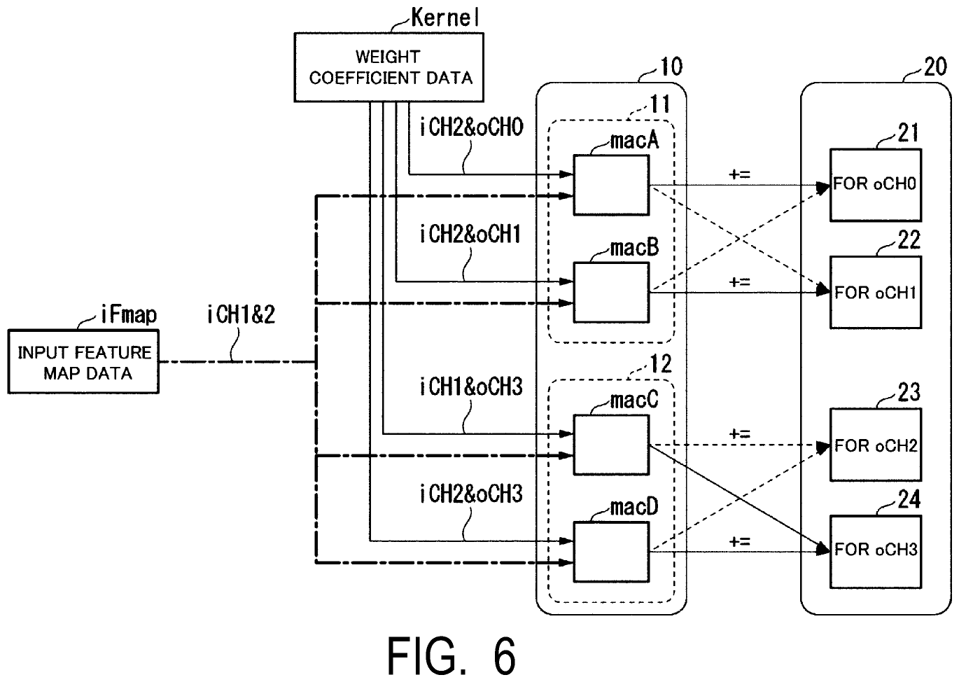

Next, an example of second processing when sparsity has occurred in kernel data will be described with reference to FIGS. 4 and 6.

FIG. 6 is a diagram showing an example of second processing when sparsity has occurred in kernel data according to the present embodiment.

In the second processing, the kernel data iCH1 & oCH1 is a zero matrix in the first set 201. Therefore, the operation circuit 1 skips the kernel data iCH1 & oCH1 in the first set 201, performs an arithmetic operation on the kernel data iCH2 & oCH0 preceding by one, and performs an arithmetic operation on the kernel data iCH2 & oCH1.

Accordingly, as shown in FIG. 6, the MAC operation unit macA stores the convolution integration result of iCH2*oCH0 in the memory 21 for oCH0 by adding the same thereto. The MAC operation unit macB stores the convolution integration result of iCH2*oCH1 in the memory 21 for oCH0 by adding the same thereto.

As a result, the arithmetic operation result of iCH0*oCH0+iCH1*oCH0+iCH2*oCH0 is stored in the memory 21 for oCH0. The arithmetic operation result of iCH2*oCH1 is stored in the memory 22 for oCH1.

As shown in FIG. 6, the MAC operation unit macC stores the convolution integration result of iCH1*oCH3 in the memory 24 for oCH3 by adding the same thereto.

In the second set 202, the kernel data iCH2 & oCH2 is a zero matrix. Therefore, the operation circuit 1 performs an arithmetic operation on the kernel data iCH1 & oCH3, skips the kernel data iCH2 & oCH2 in the second set 202, and performs an arithmetic operation on the kernel data iCH2 & oCH3 preceding by one. The MAC operation unit macD stores the convolution integration result of iCH2*oCH3 in the memory 24 for oCH3 by adding the same thereto.

As a result, the arithmetic operation result stored in the memory 23 for oCH2 is not newly added, and the arithmetic operation result of iCH1*oCH2 remains stored. The arithmetic operation result of iCH0*oCH3+iCH1*oCH3+iCH2*oCH3 is stored in the memory 24 for oCH3.

### (Third Processing)

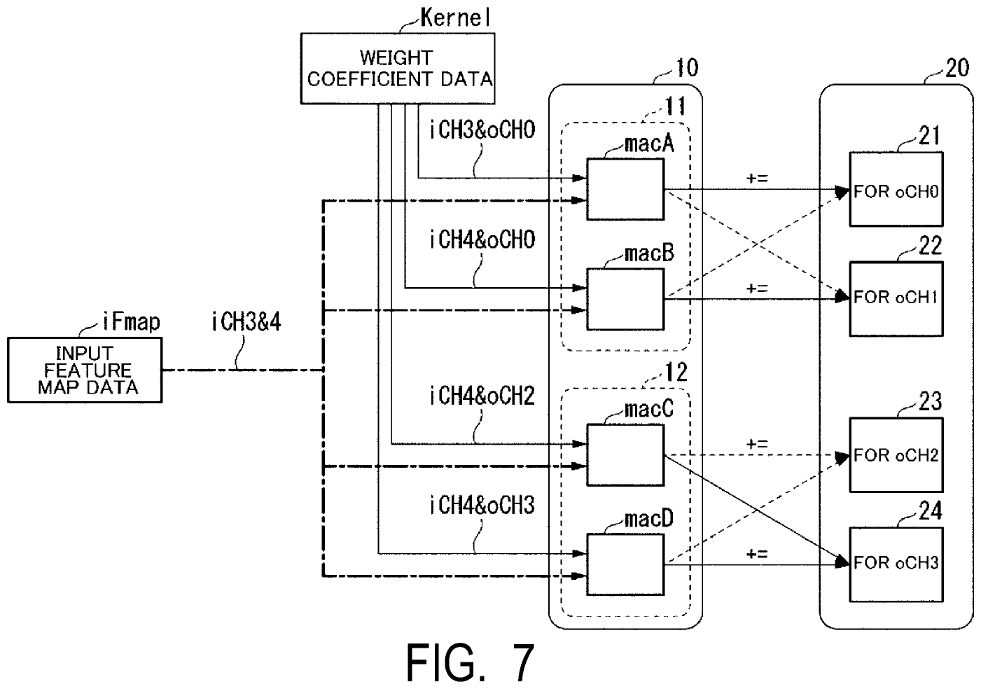

Next, an example of third processing when sparsity has occurred in kernel data will be described with reference to FIGS. 4 and 7.

FIG. 7 is a diagram showing an example of third processing when sparsity has occurred in kernel data according to the present embodiment.

In the third processing, the kernel data iCH3 & oCH1 is a zero matrix in the first set 201. Therefore, the operation circuit 1 performs an arithmetic operation on the kernel data iCH3 & oCH0, skips the kernel data iCH3 & oCH1 in the first set 201, and performs an arithmetic operation on the kernel data iCH4 & oCH0 preceding by one.

Accordingly, as shown in FIG. 6, the MAC operation unit macA stores the convolution integration result of iCH3*oCH0 in the memory 21 for oCH0 by adding the same thereto. The MAC operation unit macB stores the convolution integration result of iCH4*oCH0 in the memory 21 for oCH0 by adding the same thereto.

As a result, the arithmetic operation result of iCH0*oCH0+iCH1*oCH0+iCH2*oCH0+iCH2*oCH0+iCH4*oCH0 is stored in the memory 21 for oCH0. The arithmetic operation result stored in the memory 22 for oCH1 is not newly added, and the result of iCH2*oCH1 is stored. Since kernel data iCH4 & oCH1 is a zero matrix in the first set 201, as shown in FIG. 6, processing of the first set 201 is completed after being performed three times.

As shown in FIG. 6, the kernel data iCH3 & oCH2 and the kernel data iCH3 & oCH3 are zero matrices in the second set 202. Therefore, the operation circuit 1 skips the kernel data iCH2 & oCH2 in the second set 202, performs an arithmetic operation on kernel data iCH4 & oCH2 preceding by two (skips kernel data corresponding to two channels), and performs an arithmetic operation on the kernel data iCH4 & oCH3. The MAC operation unit macC stores the convolution integration result of iCH4*oCH2 in the memory 23 for oCH2 by adding the same thereto. The MAC operation unit macD stores the convolution integration result of iCH4*oCH3 in the memory 24 for oCH3 by adding the same thereto.

As a result, the arithmetic operation result of iCH1*oCH2+iCH4*oCH2 is stored in the memory 23 for oCH2. The arithmetic operation result of iCH0*oCH3+iCH1*oCH3+iCH2*oCH3+iCH4*oCH3 is stored in the memory 24 for oCH3. Processing of the second set 202 is completed after being performed three times.

In this manner, convolution operation results from iCH0 to iCH4 in each oCH are stored in each memory in the present embodiment. Since the arithmetic operation result stored in the memory becomes the final arithmetic operation result, that is, the output feature map data oFmap, the operation circuit 1 uses the data of the memory as a convolution layer result.

However, processing needs to be performed five times in the conventional method. On the other hand, according to the present embodiment, processing is performed three times, and thus the processing time can be reduced by 40%, for example, and the operation speed can be considerably increased.

In the present embodiment, it is necessary to supply the input feature map data iFmap data of a plurality of input channels to the MAC operation units and thus the bus width of the input data becomes larger than that of the conventional one, but if the bus width is N times that of the conventional one, the input feature map data iFmap extending over n channels can be supplied. Further, in the present embodiment, it is possible to curb a situation in which skipping cannot be performed due to insufficient input feature map data iFmap data supply capability by making n sufficiently large. However, if the bus width is sufficiently high, circuit scale increase and the like due to increase in the bus width becomes a problem and thus, for example, the following restrictions may be added.
Restriction 1 Input feature map data iFmap data can be supplied up to two channels by setting n=2.
Restriction 2 Processing waits without performing skip processing in which input feature map data iFmap of (n+1) or more channels is required.

In the example shown in FIGS. 4 to 7, if n is 2 or more, skip processing is not restricted, and it is not necessary to simultaneously supply input feature map data of n+1=3 channels. In addition, it is considered that skip processing is not limited so much even in the case of n is about 2 or 3.

### <Assignment of MAC Operation Units to Kernel Data Sets>

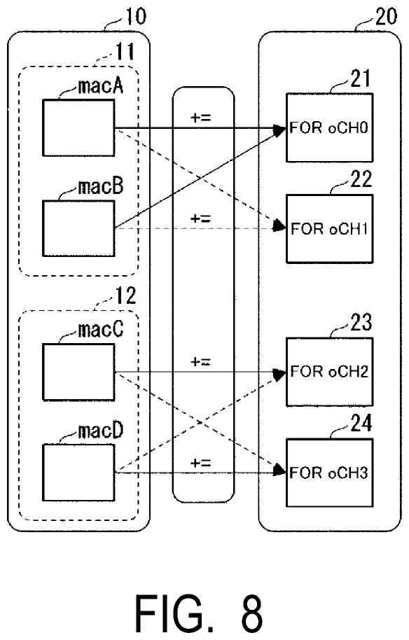

Next, assignment of MAC operation units to kernel data sets will be described. FIG. 8 is a diagram showing assignment of MAC operation units to kernel data sets in the case of k=2 according to the present embodiment. The number of oCH in one set is denoted by k.

For example, in the case where two circuits of the MAC operation unit macA and the MAC operation unit macB are allocated with oCH0 and oCH1 as one set, as shown in FIG. 8, whether a result of an arithmetic operation performed by the MAC operation unit macA is a result of mac arithmetic operation of oCH0 or a result of a product-sum operation of oCH1 changes for each processing. Therefore, a memory and a MAC operation unit do not correspond to each other one to one, and wiring from one MAC operation unit to two memories is required as shown in FIG. 8. From the viewpoint of a memory, for example, a selector circuit and wiring for selecting which one of the two MAC operation units is required.

### (When k is Small)

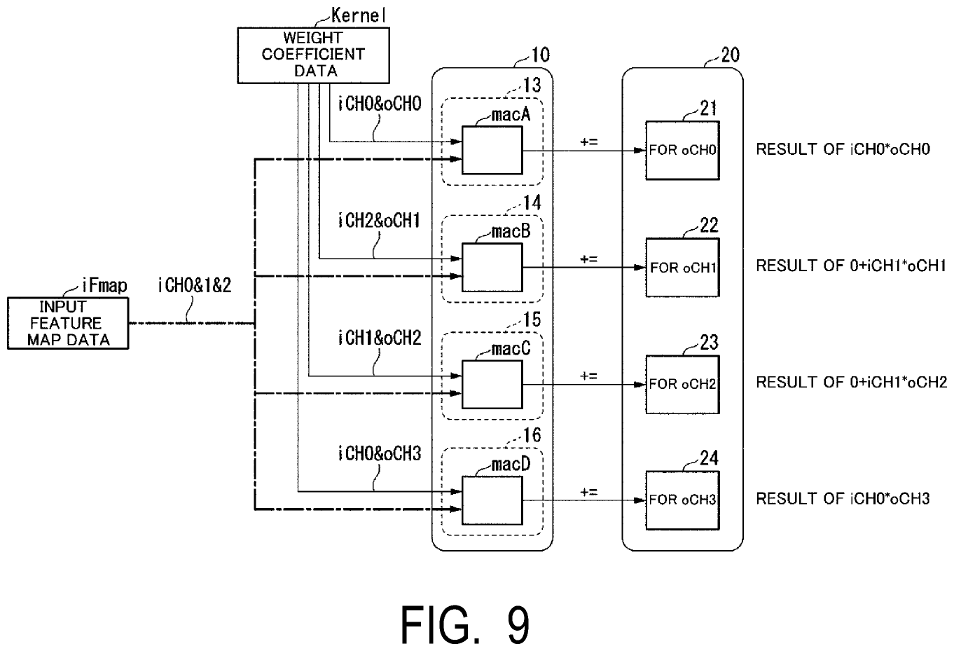

When k is small, for example, when k=1 which is the minimum, as shown in FIG. 9, one oCHn is allocated to each of sets 13 to 16, and thus the number of sets is equal to oCH_num. FIG. 9 is a diagram showing an example of correspondence between the MAC operation unit and the memory in the case of k=1. In the example shown in FIG. 9, kernel data is that shown in FIG. 5 and includes a zero matrix. In this example, a zero matrix is skipped and preceding kernel data is processed.

Therefore, the MAC operation unit macA performs a convolution operation of iCH0*oCH0 and stores the operation result in the memory 21 for oCH0 by adding the same thereto, and the MAC operation unit macB performs a convolution operation of 0+iCH2*oCH1 and stores the operation result in the memory 22 for oCH1 by adding the same thereto. The MAC operation unit macC performs a convolution operation of 0+iCH1*oCH2 and stores the operation result in the memory 23 for oCH2 by adding the same thereto, and the MAC operation unit macD performs a convolution operation of iCH0*oCH3 and stores the operation result in the memory 24 for oCH3 by adding the same thereto.

In the case of k=1, for example, oCH1 is 4 among 5 sparse kernel data, but oCH0 is not sparse. Therefore, the MAC operation unit macB in charge of oCH1 completes arithmetic operations through one-time processing because there skip processing is performed four times, but the MAC operation unit macA in charge of oCH0 cannot perform skip processing and thus needs to perform processing five times. In this manner, in the case of k=1, if a product-sum operation of an input channel preceding by one in the corresponding output channel is performed, the MAC operation units often advance ahead by specific output channels. Therefore, in the case of k=1 in the examples of FIGS. 5 and 9, processing waits until the arithmetic operation of the MAC operation unit macA is completed as a result as this processing of the convolution layer, and thus the processing speed cannot be increased at all in processing performed five times.

Kernel data tends to have large deviation in sparsity due to output channels. That is, there are relatively many situations in which kernel data of a certain output channel is mostly sparse whereas kernel data of another output channel is hardly sparse.

Accordingly, if k is excessively small, such as k=1, it is necessary to wait until an arithmetic operation of a less sparse set is completed, and a sufficient high speed may not be expected. Therefore, it is desirable that k be 2 or more.

### (When k is Large)

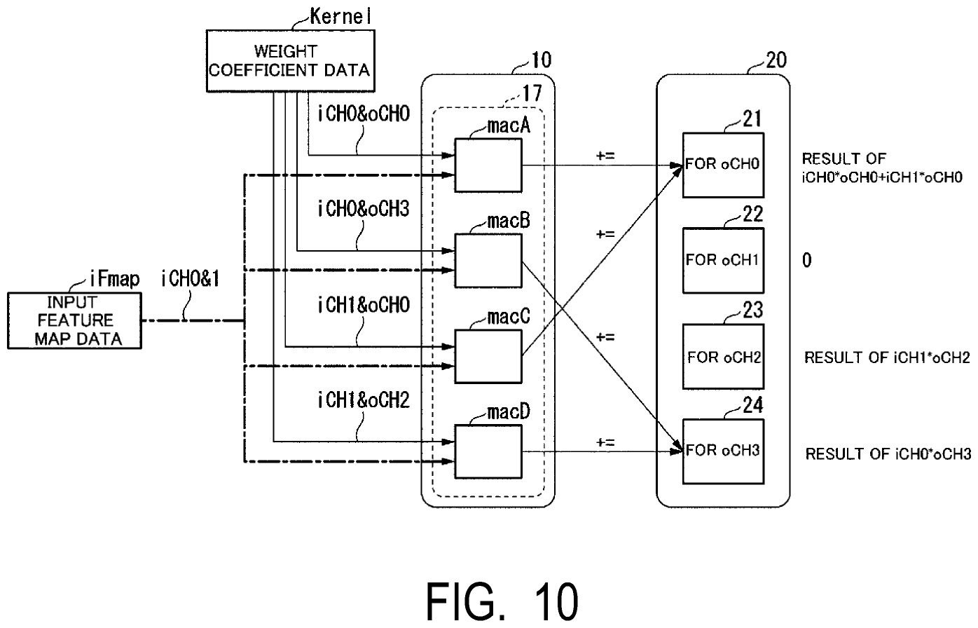

When k is large, for example, when k=oCH_num which is the maximum and k=4, there is one set 17 as shown in FIG. 10, and all oCH is allocated to one set. FIG. 10 is a diagram showing assignment of MAC operation units to a kernel data set in the case of k=4.

In the case of k=oCH_num, when kernel data becomes sparse, MAC can be advanced in any output channel. In this case, the kernel data can be packed as much as possible and disposed in the MAC operation units, and thus the speed can be maximized.

On the other hand, since the MAC operation units are likely to perform arithmetic operations on all oCH, correspondence between the MAC operation units and the memory requires wiring in a fully coupled state. In the example shown in FIG. 9, wiring in a 4×4 fully coupled state is required on the MAC operation units and on the side of the memory.

By this wiring, on the side of the memory 21 for oCH0 to the memory 24 for oCH3, a selector circuit for selecting oCH_num for determining which arithmetic operation result of oCH_num MAC operation units should be received each time is required. In the recent CNN convolution layer, the number of oCH_num is tens to hundreds, and thus there is a hardware problem in terms of a circuit area and power consumption in wiring of oCH_num fully coupled states/implementation of a selector. Therefore, it is desirable that the value of k be not excessively large.

Therefore, in the present embodiment, the value of k is set to, for example, 2 or more and less than a maximum value.

### <Example of Processing Procedure>

Next, an example of a processing procedure will be described.

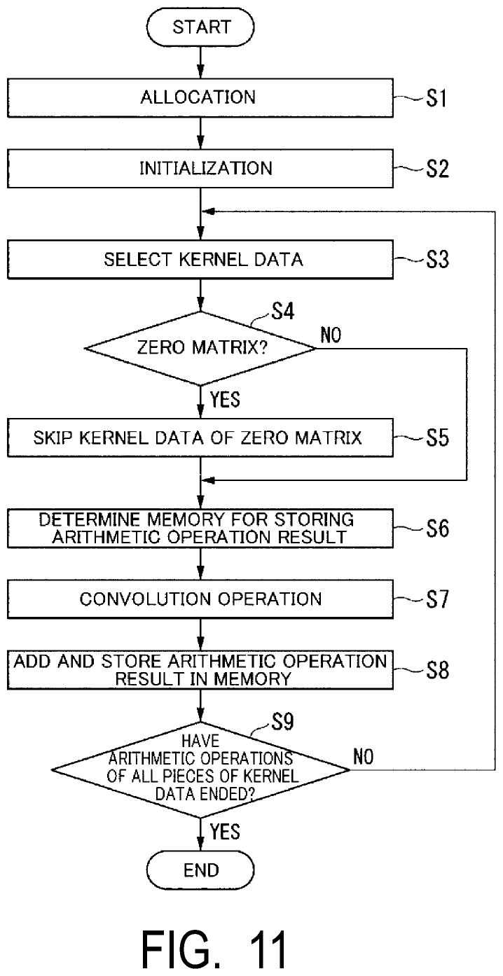

FIG. 11 is a flowchart of an example of a processing procedure of the operation circuit according to the present embodiment.

The operation circuit 1 allocates MAC operation units by determining a set of output channels of each set in advance. The operation circuit 1 allocates at least two MAC operation units (sub-operation circuits) for each set (step S1).

The operation circuit 1 initializes the value of each memory to 0 (step S2).

The operation circuit 1 selects data to be used for an arithmetic operation from kernel data (step S3).

The operation circuit 1 determines whether or not the selected kernel data is a zero matrix (S4). When the operation circuit 1 determines that the selected kernel data is a zero matrix (step S4; YES), processing proceeds to step S5. When the operation circuit 1 determines that the selected kernel data is not a zero matrix (step S4; NO), processing proceeds to step S6.

The operation circuit 1 skips the selected kernel data and re-selects kernel data preceding by one. The operation circuit 1 determines whether or not the re-selected kernel data is also a zero matrix, and when the re-selected kernel data is also a zero matrix, the operation circuit 1 skips the kernel data again and re-selects kernel data preceding by one (step S5).

The operation circuit 1 determines a memory for storing results of arithmetic operations performed by the MAC operation units on the basis of presence or absence of skipping and the number of times of skipping (step S6).

Each MAC operation unit performs convolution integration using the kernel data (step S7).

Each MAC operation unit adds arithmetic operation results and stores the same in the memory (step S8).

The operation circuit 1 determines whether or not arithmetic operations of all pieces of kernel data end (step S9). When the operation circuit 1 determines that the arithmetic operations of all pieces of kernel data end (step S9; YES), processing ends. When the operation circuit 1 determines that the arithmetic operations of all pieces of kernel data has not ended (step S9; NO), processing returns to step S3.

Note that the processing procedure described using FIG. 11 is an example and is not limited thereto. For example, the operation circuit 1 may perform a procedure for determining a memory for storing results of arithmetic operations performed by the MAC operation units on the basis of presence or absence of skipping and the number of times of skipping at the time of selecting or re-selecting kernel data. Further, kernel data is obtained by learning and is known in advance at the time of executing inference processing. Therefore, in processing, it is also possible to determine presence or absence of skipping and the memory determination procedure in advance before inference processing.

Although the above-described embodiment has described an example of MAC arithmetic operation processing in the convolutional layer of the CNN, the method of the present embodiment can be applied to other networks.

As described above, in the present embodiment, a plurality of oCH (weight coefficients) are set as one set, and a plurality of MAC operation units are allocated to each set.

Therefore, according to the present embodiment, waiting in a circuit which may occur when convolution processing of the convolutional neural network represented by a CNN is implemented in hardware can be eliminated, and thus the arithmetic operation speed can be increased.

### MODIFIED EXAMPLE

As described above, in assignment of MAC operation units to kernel data sets, that is, channel allocation, arithmetic operation speed cannot be efficiently increased if k is excessively small, and increase in the circuit area cannot be ignored if k is excessively large. Since the value of k is related to a hardware configuration such as wiring between an operation unit and a memory, it is determined at the time of hardware design and cannot be changed at the time of inference processing. On the other hand, whether an output channel is allocated to each set is not related to the hardware configuration but can be arbitrarily changed at the time of inference processing.

For this reason, the operation circuit 1 may optimize allocation of the MAC operation units such that the inference processing speed can be maximized for k determined at the time of hardware design by determining a set of output channels of each set in advance on the basis of each values of kernel data obtained at the time of inference.

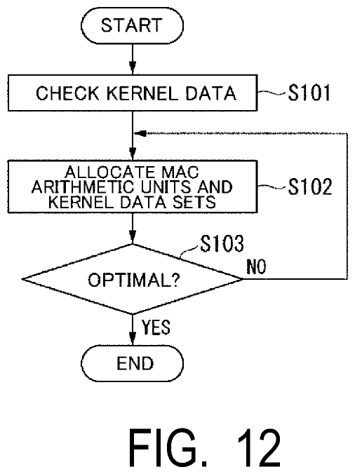

FIG. 12 is a flowchart of a procedure for optimization of allocation of MAC operation units to kernel data set in a modified example.

The operation circuit 1 checks each value of kernel data obtained at the time of inference (step S101).

The operation circuit 1 determines the number of sets of kernel data and allocates the MAC operation units to the kernel data. The operation circuit 1 may determine a set of output channels included in each set on the basis of, for example, the number and distribution of zero matrices included in the kernel data, and allocate the MAC operation units to kernel data sets. Alternatively, when processing has proceeded while skipping kernel data corresponding to a zero matrix, the operation circuit 1 may determine a set of output channels included in each set such that deviation in the number of arithmetic operations of the MAC operation unit in each set is reduced, and allocate the the MAC operation units to the kernel data before the actual convolution operation is performed (S102).

The operation circuit 1 determines a set of output channels included in each set and determines whether or not allocation of the MAC operation units to the kernel data sets can be optimized. The operation circuit 1 determines that optimization can be performed, for example, if a difference in the number of arithmetic operations of the MAC operation unit is within a predetermined value (S103). When the operation circuit 1 determines that optimization can be performed (step S103; YES), processing ends. When the operation circuit 1 determines that optimization cannot be performed (step S103; NO), processing returns to step S102.

After the optimization procedure described using FIG. 12, the operation circuit 1 performs the arithmetic operation processing shown in FIG. 11. Further, the procedure and method of optimization processing described using FIG. 12 are examples and are not limited thereto.

As described above, in the modified example, allocation of the MAC operation units to kernel data, that is, channels to be assigned to a set, is optimized.

Therefore, according to the modified example, the arithmetic operation speed can be further increased.

Although the embodiments of the present invention have been described in detail with reference to the drawings, specific configurations are not limited to these embodiments, and designs and the like within a range that does not deviating from the gist of the present invention are also included.

### INDUSTRIAL APPLICABILITY

The present invention is applicable to various inference processing devices.

### REFERENCE SIGNS LIST

1 Operation circuit
10 Sub-operation circuit
20 Memory
macA, macB, macC, macD MAC operation unit
21 Memory for oCH0
22 Memory for oCH1
23 Memory for oCH2
24 Memory for oCH3

1. An operation circuit for performing a convolution operation of input feature map information supplied as a plurality of channels and coefficient information supplied as a plurality of channels, the operation circuit comprising:
a set including at least two channels of an output feature map based on output channels; and
at least three sub-operation circuits,
wherein at least two sub-operation circuits are allocated for each set,
the sub-operation circuits included in the set execute processing of a convolution operation of the coefficient information and the input feature map information included in the set,
when a specific channel of the output feature map is a zero matrix, a sub-operation circuit that performs a convolution operation of the zero matrix executes processing of a convolution operation of the coefficient information and the input feature map information to be supplied next from a channel of the output feature map and a channel of the input feature map included in the set, and
a result of the convolution operation is output for each channel of the output feature map.

2. The operation circuit according to claim 1, wherein the sub-operation circuit outputs a sum of convolution operation results for each channel of the input feature map for each channel of the output feature map with respect to a convolution operation result for each channel of the input feature map obtained as a result of an arithmetic operation for each channel of the input feature map information.

3. The operation circuit according to claim 1, wherein, when a specific channel of the output feature map is a zero matrix, the sub-operation circuit that performs a convolution operation of the zero matrix also executes processing of a convolution operation of the coefficient information and the input feature map information to be supplied next from a channel of the output feature map and a channel of the input feature map included in the set when a specific channel of the output feature map is a zero matrix when executing a convolution operation of the coefficient information and the input feature map information to be supplied next from a channel of the output feature map and a channel of the input feature map included in the set.

4. The operation circuit according to claim 1, wherein sub-operation circuits less than the number of channels are allocated for each set.

5. The operation circuit according to claim 1, wherein channels allocated to the set are optimized by allocating the sub-operation circuit corresponding to the set on the basis of each value of kernel data obtained at the time of inference.

6. An operation method for causing an operation circuit including a set including at least two channels of an output feature map based on output channels, and at least three sub-operation circuits to execute a convolution operation of input feature map information supplied as a plurality of channels and coefficient information, the operation method comprising:
allocating at least two sub-operation circuits for each set;
causing the sub-operation circuits included in the set to execute processing of a convolution operation of the coefficient information and the input feature map information included in the set;
when a specific channel of the output feature map is a zero matrix, causing a sub-operation circuit that performs a convolution operation of the zero matrix to execute processing of a convolution operation of the coefficient information and the input feature map information to be supplied next from a channel of the output feature map and a channel of the input feature map included in the set; and
outputting a result of the convolution operation for each channel of the output feature map.

7. A non-transitory computer readable storage medium storing a program causing a computer to realize the operation circuit according to claim 1.
